(19) United States
(12) Patent Application Publication
(10) Pub. No.: US 2013/0207877 A1
(43) Pub. Date: Aug. 15, 2013

(54) RADIO FREQUENCY ANTENNA ARRAY WITH SPACING ELEMENT

(71) Applicants: Victor Shtrom, Los Altos, CA (US); Bernard Baron, Mountain View, CA (US); Chia Ching Ling, San Jose, CA (US)

(72) Inventors: Victor Shtrom, Los Altos, CA (US); Bernard Baron, Mountain View, CA (US); Chia Ching Ling, San Jose, CA (US)

(21) Appl. No.: 13/396,484

(22) Filed: Feb. 14, 2012

(51) Int. Cl. H01Q 21/06

(52) U.S. Cl. 343/893

(57) ABSTRACT

A spacing member is positioned between a pair of antenna members. The two antenna members may be horizontally polarized or vertically polarized and positioned next to each other to provide an increased gain. The spacing element may be placed between the antenna members and have a thickness corresponding to the characteristic impedance of the antenna transmission line. The characteristic impedance may be determined based on the width of the transmission line. The spacing member may be radio-frequency (RF) transparent and may adhere to either or both of the antenna elements. The spacing member may be implemented as a plastic double sided tape or a uniform piece of plastic having one or more adhesive layers.

### BACKGROUND OF INVENTION

1. Field of the Invention

The present invention generally relates to wireless communications and more particularly to changing radio frequency (RF) emission patterns with respect to one or more antenna arrays.

2. Description of the Prior Art

In wireless communications systems, there is an ever-increasing demand for higher data throughput and a corresponding drive to reduce interference that can disrupt data communications. For example, a wireless link in an Institute of Electrical and Electronic Engineers (IEEE) 802.11 network may be susceptible to interference from other wireless access points and stations, radio transmitting devices in the vicinity of the network, and changes or disturbances in the wireless link environment between an access point and remote receiving node. In some instances, the interference may degrade the wireless link thereby forcing communication at a lower data rate. The interference may, in some instances, be sufficiently strong as to disrupt the wireless link altogether.

One solution is to utilize a diversity antenna scheme. In such a solution, a data source is coupled to two or more physically separated omnidirectional antennas. An access point may select one of the omnidirectional antennas by which to maintain a wireless link. Because of the separation between the omnidirectional antennas, each antenna experiences a different signal environment and corresponding interference level with respect to the wireless link. A switching network couples the data source to whichever of the omnidirectional antennas experiences the least interference in the wireless link.

Notwithstanding, many high-gain antenna environments still encounter--or cause--electromagnetic interference (EMI). This interference may be encountered (or created) with respect to another nearby wireless environments (e.g., between the floors of an office building or hot spots scattered amongst a single room). In some instances, the mere operation of a power supply or electronic equipment can create electromagnetic interference.

One solution to combat electromagnetic interference is to utilize shielding in or proximate an antenna enclosure. Shielding a metallic enclosure is imperfect, however, because the conductivity of all metals is finite. Because metallic shields have less than infinite conductivity, part of the field is transmitted across the boundary and supports a current in the metal. The amount of current flow at any depth in the shield and the rate of decay are governed by the conductivity of the metal, its permeability, and the frequency and amplitude of the field source.

With interference present in most environments, it is desirable to have a low-cost and effective solution to providing an antenna apparatus with reduced interference.

### SUMMARY OF THE INVENTION

The presently claimed invention utilizes a spacing member positioned between antenna members. Two associated antenna members may be positioned next to each other to provide an increased gain. The spacing element may be placed between the antenna members and have a thickness related to the characteristic impedance of the antenna transmission line. The characteristic impedance may be determined based on the width of the transmission line. The spacing member may be radio-frequency (RF) transparent and may adhere to either or both of the antenna elements. The spacing member may include a plastic double sided tape, a uniform piece of plastic having one or more adhesive layers, or some other RF transparent material.

An embodiment of a wireless device may include an antenna array and a spacer element. The antenna array may include a plurality of antenna elements to generate a substantially omnidirectional radiation pattern. Each of the plurality of antenna elements may include a first antenna member and a second antenna member. The spacer element may be displaced between the first antenna member and the second antenna member.

### BRIEF DESCRIPTION OF DRAWINGS

FIG. 1 illustrates a wireless MIMO antenna system having multiple antennas and multiple radios.

FIG. 2 illustrates a horizontally polarized antenna member pair for mounting on a printed circuit board.

FIG. 3 illustrates a vertically polarized antenna member pair for mounting on a printed circuit board.

FIG. 4 illustrates a top view of a horizontally polarized antenna member pair.

FIG. 5 illustrates a rear view of a horizontally polarized antenna member pair.

FIG. 6 illustrates a top view of a vertically polarized antenna member pair.

FIG. 7 illustrates a side view of a vertically polarized antenna member pair.

FIG. 8 illustrates a side view of a spacing member having an upper and lower adhesive layer.

FIG. 9 illustrates a side view of an adhesive tape spacing member.

### DETAILED DESCRIPTION

Embodiments of the present invention implement a spacing member positioned between a pair of antenna members. The two antenna members may be horizontally polarized or vertically polarized and positioned next to each other to provide an increased gain. The spacing element may be placed between the antenna members and have a thickness corresponding to the characteristic impedance of the antenna transmission line. The characteristic impedance may be determined based on the width of the transmission line. The spacing member may be radio-frequency (RF) transparent and may adhere to either or both of the antenna elements. The spacing member may be implemented as a plastic double sided tape or a uniform piece of plastic having one or more adhesive layers. The antenna member pair having the spacing member may be used in a wireless antenna system.

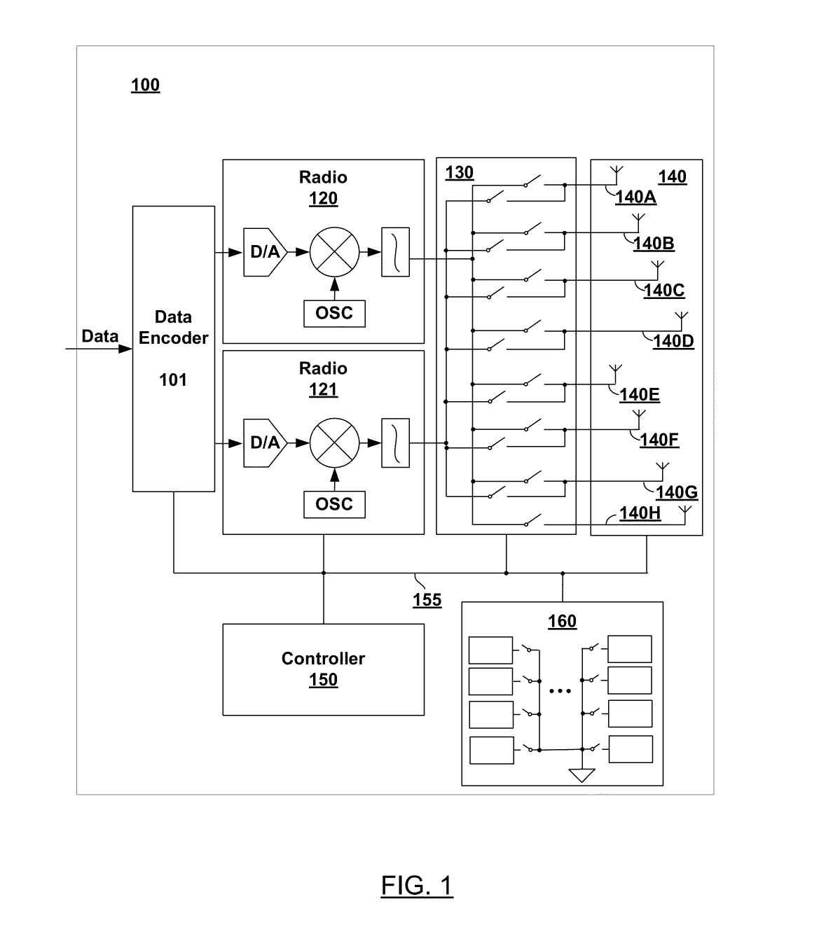

FIG. 1 illustrates a wireless MIMO antenna system having multiple antennas and multiple radios. The wireless MIMO antenna system 100 may be representative of a transmitter and/or a receiver such as an 802.11 access point or an 802.11 receiver. System 100 may also be representative of a set-top box, a laptop computer, television, Personal Computer Memory Card International Association (PCMCIA) card, Voice over Internet Protocol (VoIP) telephone, or handheld gaming device.

Wireless MIMO antenna system 100 may include a communication device for generating a radio frequency (RF) signal (e.g., in the case of transmitting node). Wireless MIMO antenna system 100 may also or alternatively receive data from a router connected to the Internet. Wireless MIMO antenna system 100 may then transmit that data to one or more of the remote receiving nodes. For example, the data may be video data transmitted to a set-top box for display on a television or video display.

The wireless MIMO antenna system 100 may form a part of a wireless local area network (e.g., a mesh network) by enabling communications among several transmission and/or receiving nodes. Although generally described as transmitting to a remote receiving node, the wireless MIMO antenna system 100 of FIG. 1 may also receive data subject to the presence of appropriate circuitry. Such circuitry may include but is not limited to a decoder, down conversion circuitry, samplers, digital-to-analog converters, filters, and so forth.

Wireless MIMO antenna system 100 includes a data encoder 101 for encoding data into a format appropriate for transmission to the remote receiving node via the parallel radios 120 and 121 illustrated in FIG. 1. While two radios are illustrated in FIG. 1, additional radios or RF chains may be utilized. Data encoder 101 may include data encoding elements such as direct sequence spread-spectrum (DSSS) or Orthogonal Frequency Division Multiplex (OFDM) encoding mechanisms to generate baseband data streams in an appropriate format. Data encoder 101 may include hardware and/or software elements for converting data received into the wireless MIMO antenna system 100 into data packets compliant with the IEEE 802.11 format. Such software elements may be embedded in memory or other non-transitory computer readable storage media and coupled to appropriate processing components. In some instances, the appropriate conversion elements may be implemented in the context of a hardware element such as an application specific processor.

Radios 120 and 121 as illustrated in FIG. 1 include transmitter or transceiver elements configured to upconvert the baseband data streams from the data encoder 101 to radio signals. Radios 120 and 121 thereby establish and maintain the wireless link. Radios 120 and 121 may include direct-to-RF upconverters or heterodyne upconverters for generating a first RF signal and a second RF signal, respectively. The first and second RF signals are generally at the same center frequency and bandwidth but may be offset in time or otherwise space-time coded.

Wireless MIMO antenna system 100 further includes a circuit (e.g., switching network) 130 for selectively coupling the first and second RF signals from the parallel radios 120 and 121 to an antenna apparatus 140 having multiple antenna elements 140A-H. Antenna elements 140A-H may include individually selectable antenna elements such that each antenna element 140A-H may be electrically selected (e.g., switched on or off). By selecting various combinations of the antenna elements 140A-H, the antenna apparatus 140 may form a “pattern agile” or reconfigurable radiation pattern. If certain or substantially all of the antenna elements 140A-H are switched on, for example, the antenna apparatus 140 may form an omnidirectional radiation pattern. Through the use of MIMO antenna architecture, the pattern may include both vertically and horizontally polarized energy, which may also be referred to as diagonally polarized radiation. Alternatively, the antenna apparatus 140 may form various directional radiation patterns, depending upon which of the antenna elements 140A-H are turned on.

The RF switches within circuit 130 may be PIN diodes, gallium arsenide field-effect transistors (GaAs FETs), or virtually any RF switching device. The PIN diodes comprise single-pole single-throw switches to switch each antenna element either on or off (i.e., couple or decouple each of the antenna elements to the radios 120 and 121). A series of control signals may be applied via a control bus 155 to bias each PIN diode. With the PIN diode forward biased and conducting a DC current, the PIN diode switch is on, and the corresponding antenna element is selected. With the diode reverse biased, the PIN diode switch is off. In some embodiments, one or more light emitting diodes (LEDs) may be included in the coupling network as a visual indicator of which of the antenna elements is on or off. An LED may be placed in circuit with the PIN diode so that the LED is lit when the corresponding antenna element is selected.

Further, the antenna apparatus may include switching at RF as opposed to switching at baseband. Switching at RF means that the communication device requires only one RF up/downconverter. Switching at RF also requires a significantly simplified interface between the communication device and the antenna apparatus. For example, the antenna apparatus provides an impedance match under all configurations of selected antenna elements, regardless of which antenna elements are selected.

Wireless MIMO antenna system 100 includes pattern shaping elements 160. Pattern shaping elements 160 in FIG. 1 extend from a printed circuit board. The pattern shaping elements may include directors and reflectors selectively connected to ground using, for example, a PIN diode. Directors may include passive elements that constrain the directional radiation pattern, for example, to increase the gain of the antenna member pair. Pattern shaping elements such as reflectors and directors are generally known in the art. The reflectors and directors may be metal objects having any shape and placed near an antenna array such as an antenna member pair mounted on a printed circuit board.

Wireless MIMO antenna system 100 may also include a controller 150 coupled to the data encoder 101, the radios 120 and 121, the circuit 130, and pattern shaping elements 160 via a control bus 155. The controller 150 may include hardware (e.g., a microprocessor and logic) and/or software elements to control the operation of the wireless MIMO antenna system 100.

The controller 150 may select a particular configuration of antenna elements 140A-H that minimizes interference over the wireless link to the remote receiving device. If the wireless link experiences interference, for example due to other radio transmitting devices, or changes or disturbances in the wireless link between the wireless MIMO antenna system 100 and the remote receiving device, the controller 150 may select a different configuration of selected antenna elements 140A-H via the circuit 130 to change the resulting radiation pattern and minimize the interference. Controller 150 may also select one or more pattern shaping elements 160. For example, the controller 150 may select a configuration of selected antenna elements 140A-H and pattern shaping elements 160 corresponding to a maximum gain between the wireless system 100 and the remote receiving device. Alternatively, the controller 150 may select a configuration of selected antenna elements 140A-H and pattern shaping elements 160 corresponding to less than maximal gain, but corresponding to reduced interference in the wireless link.

Controller 150 may also transmit a data packet using a first subgroup of antenna elements 140A-H coupled to the radio 120 and simultaneously send the data packet using a second group of antenna elements 140A-H coupled to the radio 121. Controller 150 may change the substrate of antenna elements 140A-H coupled to the radios 120 and 121 on a packet-by-packet basis. Methods performed by the controller 150 with respect to a single radio having access to multiple antenna elements are further described in, for example, U.S. patent publication number US 2006-0040707 A1. These methods are also applicable to the controller 150 having control over multiple antenna elements and multiple radios.

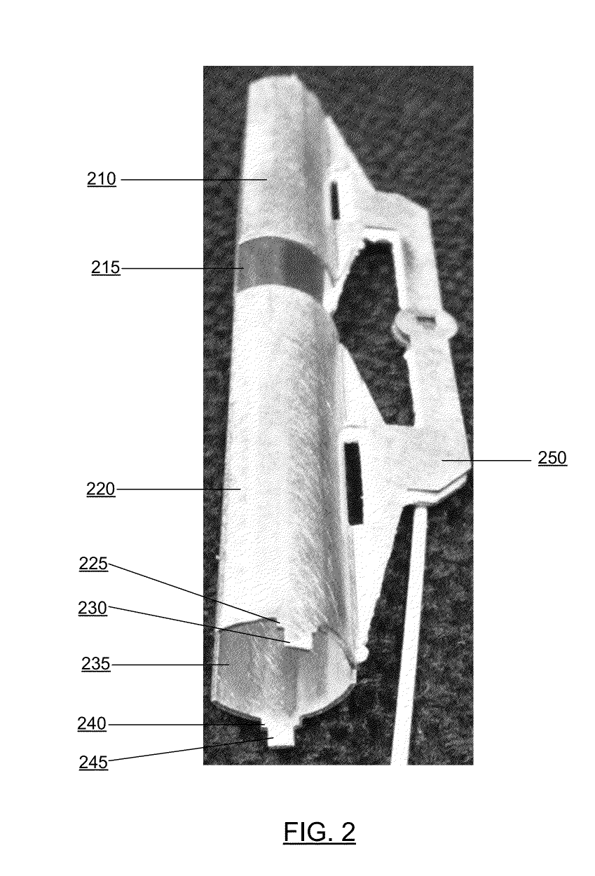

FIG. 2 illustrates an antenna element (e.g., a dipole) for emitting a horizontally polarized radiation pattern for mounting on a printed circuit board. The antenna element illustrated in FIG. 2 includes a first antenna member and a second antenna member. The first antenna member includes an upper portion 210 and a lower portion 220. The second antenna member also includes an upper portion 215 and a lower portion 235. The antenna elements are connected at an RF feed point 250. When connected together, the first antenna member and second antenna member form an antenna member pair having a barrel-type shape with a slit near the middle of the structure. The antenna member pair of FIG. 2 may transmit a radiation pattern having a frequency of about 5.0 GHZ in compliance with IEEE 802.11n.

The horizontally polarized antenna member pair of FIG. 2 may be mounted to the surface of a PCB. Antenna member lower portions 220 and 235 include tabs 230 and 245, respectively. The tabs are constructed to fit into a printed circuit board and may be secured via solder. Above each tab on lower portions 220 and 235 are shoulders 225 and 240, respectively. The shoulder is designed to maintain a spacing of each antenna lower portion above the printed circuit board.

An RF signal may be fed to the horizontally polarized antenna member pair of FIG. 2 via connector 250. Connector 250 is formed by bending a tab from antenna member 210 into an aperture of antenna element 215, and soldering the connection between the elements.

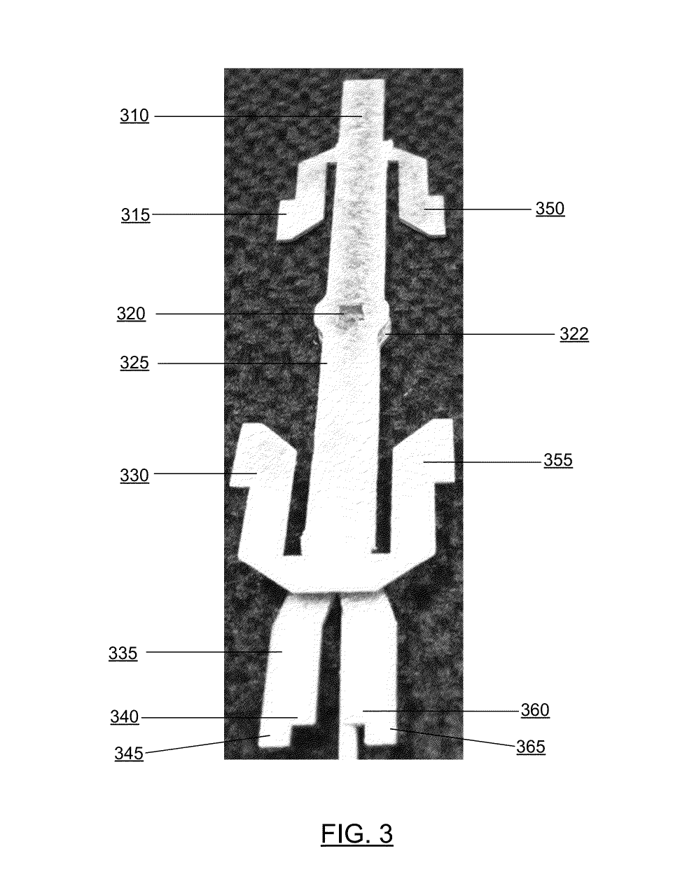

FIG. 3 illustrates a vertically polarized antenna member pair for mounting on a printed circuit board. The dipole of FIG. 3 includes a first antenna member 325 and a second antenna member 322. The first antenna member includes a first end 310 and a second end having two finger elements 330 and 355. The second antenna member has finger elements which are about the same as the first antenna member. The antenna members are connected together to align along their central axis such that the second antenna member is upside down with respect to the first antenna member. Hence, the fingers of the second antenna member are near the first end of the first antenna member, which is the opposite end of the fingers on the first antenna member. The antenna members are connected at an RF feed point 320. When connected together, the first antenna member and second antenna member form an antenna member pair which provides a horizontally polarized radiation pattern. The antenna member pair of FIG. 3 may transmit a radiation pattern having a frequency of about 5.0 GHZ in compliance with IEEE 802.11n.

As illustrated, second antenna member 322 includes finger elements 315 and 350. Finger elements 315 and 350 opposite to and form a magnetic pair with finger elements 330 and 355 of first antenna member 325.

The vertically polarized antenna member pair of FIG. 3 may be mounted to the surface of a PCB using tabs and shoulders. Antenna member 322 includes tabs 345 and 365 which may be received and soldered to a PCB. Above tabs 345 and 355 are shoulders 340 and 360, respectively. The shoulder is designed to engage the surface of the PCB.

An RF signal may be fed to the vertically polarized antenna member pair of FIG. 3 via RF feed point 320. RF feed point 320 is formed by bending a tab from antenna element 325 into an aperture of antenna element 322 and soldering the antenna members together.

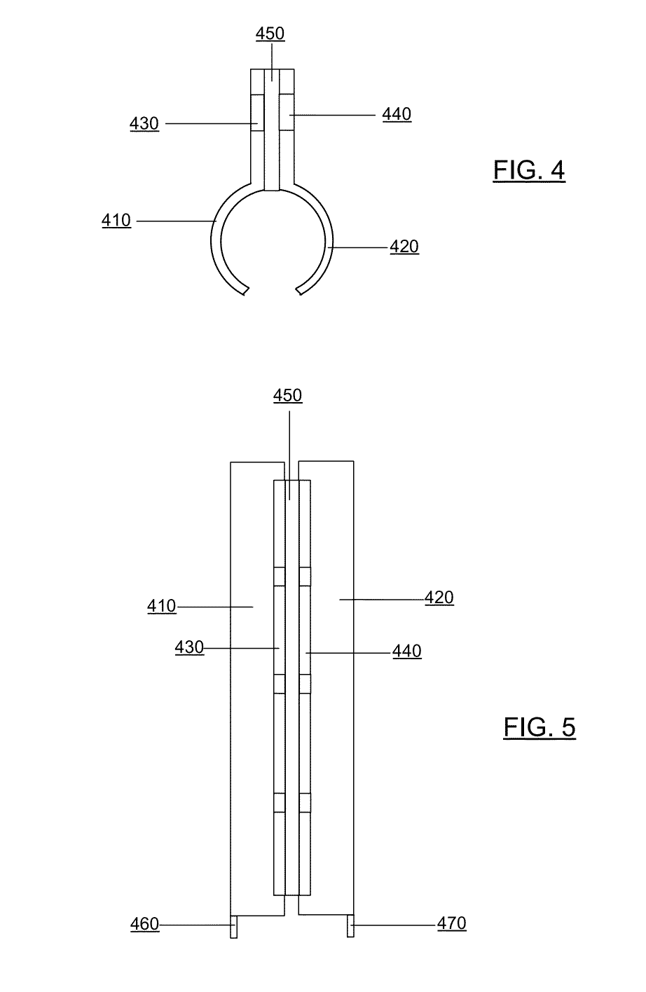

FIG. 4 illustrates a top view of a horizontally polarized antenna member pair. The antenna member pair includes a first antenna member having a barrel portion 410 and connector portion 430 and a second member pair having a barrel portion 420 and connector portion 440. Connector portion 430 and connector portion 440 are each attached to spacing member 450. Spacing member 450 may extend along the entire depth of connector portions 430 and 440.

The spacing member may have a uniform thickness to maintain a constant distance between the first antenna member and second antenna member of the antenna member pair. In some embodiments, the spacing member may have a thickness of about 0.03 inches wide. The spacing member material may be transparent to a radio frequency signal so that no signal power is lost, reflected, or otherwise affected by the spacing member. The spacing member may be formed by an adhesive tape that is cut to fit between and match the general shape of the connector portions.

FIG. 5 illustrates a rear view of a horizontally polarized antenna member pair. The antenna member pair of FIG. 5 includes barrel portions 410 and 420 and connector portions 430 and 440, and tab portions 460 and 470. Spacing member 450 extends between connector portions 430 and 440. As illustrated, spacing member 450 may extend along the entire length of connector portions 430 and 440.

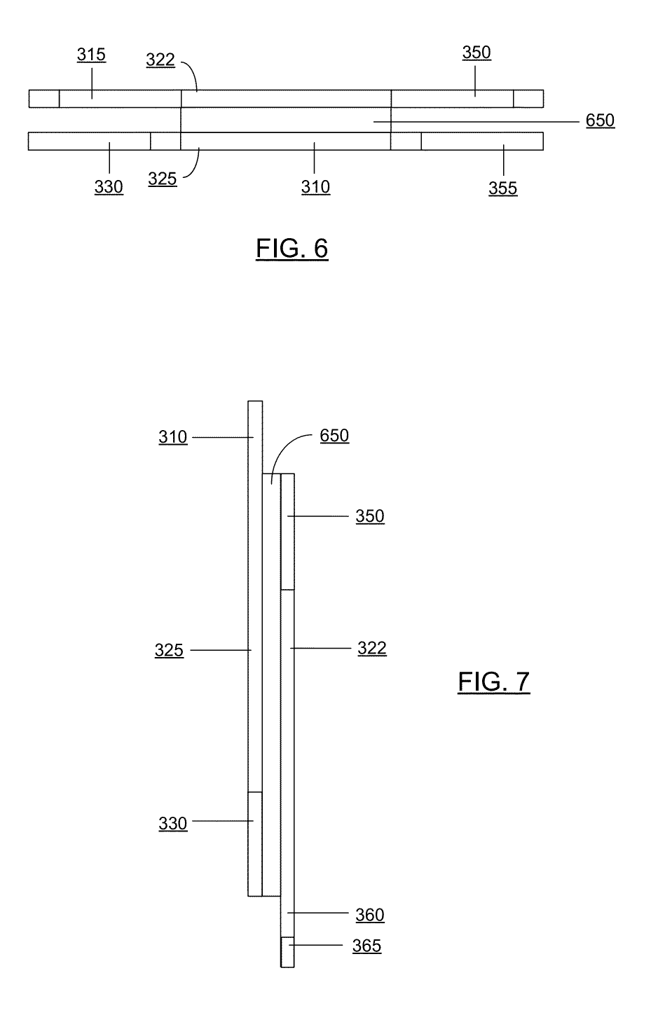

FIG. 6 illustrates a top view of a vertically polarized antenna member pair. The vertically polarized antenna member pair of FIG. 5 includes first antenna member 325 and second antenna member 322. First antenna element 322 includes finger elements 315 and 350. Second antenna element 325 includes finger elements 330 and 355 and top end 310. A spacing member 650 is located between the first antenna element 322 and second antenna element 325. Spacing member 650 extends along the entire width of top end 310 between the two antenna elements.

FIG. 7 illustrates a side view of a vertically polarized antenna member pair. Spacing member 650 extends along the length of first antenna element 325 and 322 which is common to both elements. For example, spacing member 650 extends vertically from the bottom of spacing member 330 to the top of spacing member 350.

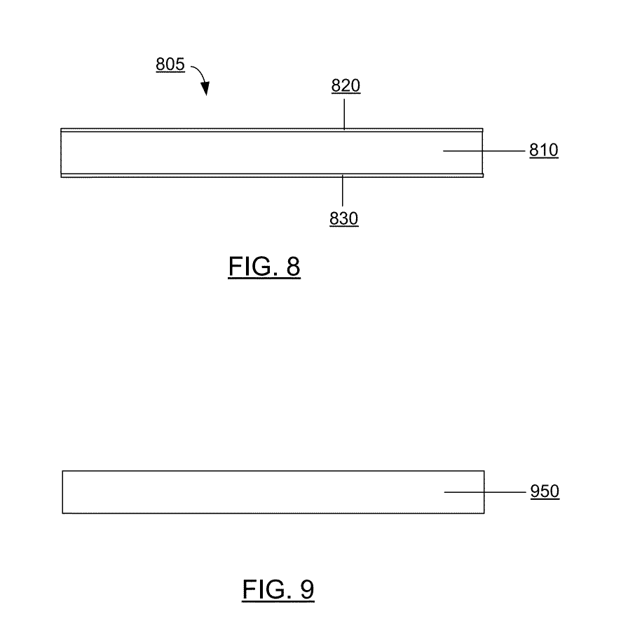

A spacing member may be implemented differently in various embodiments of the invention. FIG. 8 illustrates a side view of a spacing member 805 having an upper and lower adhesive layer. Spacing member 805 may have a core 810, an upper adhesive layer 820, and a lower adhesive layer 830. The adhesive layers may be applied to spacing member core 810 before the member is positioned between a pair of antenna elements.

FIG. 9 illustrates a side view of adhesive tape spacing member 950. The adhesive tape spacing member 950 may inherently include an adhesive on an upper surface and lower surface. When used to adhere together a pair of antenna elements together, the adhesive tape spacing member 950 may be cut to match the surface of the antenna elements. In other aspects of the present invention, the antenna element pair dimensions may be designed around the thickness, desired length and other properties of the adhesive tape spacing member 950.

The invention has been described herein in terms of several preferred embodiments. Other embodiments of the invention, including alternatives, modifications, permutations and equivalents of the embodiments described herein, will be apparent to those skilled in the art from consideration of the specification, study of the drawings, and practice of the invention. The embodiments and preferred features described above should be considered exemplary, with the invention being defined by the appended claims, which therefore include all such alternatives, modifications, permutations and equivalents as fall within the true spirit and scope of the present invention.

What is claimed is:

1. A wireless device, comprising:
an antenna array including a plurality of antenna elements, the plurality of antenna elements generating a substantially omnidirectional radiation pattern, each of the plurality of antenna elements including a first antenna member and a second antenna member; and
a spacer element displaced between the first antenna member and the second antenna member.

2. The wireless device of claim 1, wherein the spacer element is transparent to a radio frequency signal.

3. The wireless device of claim 1, wherein the spacer element is 0.03 inches wide.

4. The wireless device of claim 1, wherein the spacer element includes an adhesive tape.

5. The wireless device of claim 1, the spacer element further including an adhesive on both an upper surface and a lower surface of the spacer element, the adhesive attaching the spacer element to an outer surface of the first antenna member and an outer surface of the second antenna member.

6. The wireless device of claim 1, wherein the plurality of antenna elements are vertically positioned on a printed circuit board using one or more tabs.

7. The wireless device of claim 1, wherein the one ore more of the antenna elements are vertically polarized.

8. The wireless device of claim 1, wherein the one ore more of the antenna elements are horizontally polarized.
